(19) United States
(12) Patent Application Publication
(10) Pub. No.: US 2012/0114159 A1
(43) Pub. Date: May 10, 2012

(54) MICROPHONE AND MICROPHONE APPARATUS

(76) Inventor: Hiroshi Akino, Tokyo (JP)

(21) Appl. No.: 13/291,197

(22) Filed: Nov. 8, 2011

(30) Foreign Application Priority Data
Nov. 9, 2010 (JP) 2010-250708

(51) Int. Cl. H04R 1/00

(52) U.S. Cl. 381/369

(57) ABSTRACT

A microphone includes a microphone unit having a diaphragm, a fixed electrode and a FET as an impedance converter; a plug outputting audio signals output from the microphone unit; and a jack into which audio signals inputted in the microphone unit are inputted. While the plug of the other microphone is inserted in the jack of the microphone, the audio signals output from the other microphone unit are added to the audio signals output from the microphone unit and are output.

### BACKGROUND OF THE INVENTION

1. Field of the Invention

The present invention relates to a microphone which is to be connected to and operated along with a plurality of microphones, and a microphone apparatus including the microphones.

2. Related Background Art

Among electret condenser microphones, a known electret condenser microphone of a drain output type (two-wire system) yields an output from a drain of a FET (field-effect transistor) as an impedance converter (refer to Japanese Unexamined Patent Application Publication No. H8-33090, for example). Such a type of an electret condenser microphone is referred to as a “plug-in power system,” for example. FIG. 5 illustrates a typical electret condenser microphone of a plug-in power type.

In FIG. 5, a microphone unit 100 includes a microphone capsule 110, which has an electret member in either a diaphragm or a fixed electrode, and a FET 120 as an impedance converter. In the plug-in power system, a load resistor RL and a DC power source Vcc are connected in series to a drain D of the FET 120 such that a variable voltage across the load resistor RL is obtained from output terminals T1 and T2.

The FET 120 is of a bias built-in type having a diode and a high-value resistor which are connected between a gate G and a source S. A drain current is fixed to a drain current value (Idss) at a voltage of 0 between the gate G and the source S. Connecting a plurality of microphone units 100 in parallel to the load resistor RL synthesizes audio signals from the microphone units.

The plurality of microphone units 100 connected to the load resistor RL, however, cause the DC voltage to vary across the load resistor RL depending on the number of units. The DC voltage across the load resistor RL thus approaches the power voltage of the DC power source Vcc depending on the number of connected units. The voltage between the drain D and the source S of the FET 120 is then extremely reduced, preventing the FET 120 from operating.

To prevent a reduction in operating current of the impedance converter due to parallel connection of the microphone units, the resistance value of the load resistor RL is properly switched depending on the number of connected microphone units. Since the resistance value of the load resistor RL, however, should be switched during installation or use, it is practically cumbersome and inconvenient.

In order to address such a cumbersome and inconvenient circumstance, a method is known to use an output transformer instead of the load resistor RL. According to the method, the voltage between the drain D and the source S of the FET 120 is not reduced regardless of the number of connected microphone units (consumption current). Unfortunately, the DC current flowing to the output transformer generates DC magnetization that leads to a decline in performance of the transformer.

To address the circumstances above, a known microphone apparatus has an output transformer and a current mirror circuit in an output circuit and a plurality of microphones can be connected in parallel to the apparatus without special adjustment (refer to Japanese Unexamined Patent Application Publication No. 2006-197284, for example).

FIG. 4 illustrates a typical microphone apparatus as disclosed in Japanese Unexamined Patent Application Publication No. 2006-197284. In the microphone apparatus shown in FIG. 4, a plurality of microphone 100a to 100c are connected in parallel to a microphone apparatus main body 200. Each of the microphone 100a to 100c has the same configuration as the electret condenser microphone unit shown in FIG. 5. The microphone units 100a to 100c have microphone capsules 110a to 110c, respectively, each having an electret member in either a diaphragm or a fixed electrode; and FETs 120a to 120c, respectively, each serving as an impedance converter. The fixed electrode is connected to a gate G of each of the FETs 120a to 120c. The diaphragm is grounded along with a source S of each of the FETs 120a to 120c.

The apparatus main body 200 has a DC power source Vcc, an output transformer 201 outputting audio signals and used as a load, and a current mirror circuit 204. A primary winding 202 of the output transformer 201 is split into a first winding 202a and a second winding 202b by a center tap 202c. Drains D of the FETs 120a to 120c of the microphone units 100a to 100c, respectively, are connected in parallel to the first winding 202a. The current mirror circuit 204 is connected to the second winding 202b. The center tap 202c is connected to the positive electrode of the DC power source Vcc. A secondary winding 203 of the output transformer 201 is connected to an audio output circuit (not shown in the drawing).

In the microphone apparatus disclosed in Japanese Unexamined Patent Application Publication No. 2006-197284, the current mirror circuit 204 can generate an operating current which increases according to an increase in the number of connected microphone units. Furthermore, in the primary winding 202 of the output transformer 201, the current flows in directions opposite to each other in the first winding 202a and the second winding 202b as viewed from the center tap 202c, thus preventing saturation of the DC current. The microphone apparatus disclosed in Japanese Unexamined Patent Application Publication No. 2006-197284, however, requires the output transformer and the current mirror circuit and has a high AC impedance of the FET drains, thus susceptible to external noise.

### SUMMARY OF THE INVENTION

In view of the circumstances above, an object of the present invention is to provide a plurality of microphones connected in parallel to a power source for operation and a microphone apparatus including the microphones in a simpler configuration without using an output transformer and a current mirror circuit.

The present invention relates to a microphone that includes a microphone unit having a diaphragm, a fixed electrode and a FET as an impedance converter; a plug outputting audio signals output from the microphone unit; and a jack into which audio signals inputted in the microphone unit are inputted. While the plug of the other microphone is inserted in the jack, the audio signals output from a microphone unit of the other microphone are added to the audio signals output from the microphone unit and are output.

The present invention also relates to a microphone apparatus that includes a microphone unit having a diaphragm, a fixed electrode and a FET as an impedance converter; a plug outputting audio signals output from the microphone unit; and a jack audio signals inputted in the microphone unit are inputted. While the plug of the other microphone is inserted in the jack of the microphone, a signal line of the diaphragm of the microphone unit and the plug of the microphone are electrically connected and the audio signals output from the other microphone are added to the audio signals output from the microphone and are output.

The present invention provides a plurality of microphones connected in parallel to a power source for operation and a microphone apparatus including the microphones in a simple configuration.

### BRIEF DESCRIPTION OF THE DRAWINGS

FIG. 1 is a schematic view of a configuration of a microphone apparatus according to an embodiment of the present invention;

FIG. 2 is a circuit diagram of an exemplary microphone according to an embodiment of the present invention;

FIG. 3 is a circuit diagram illustrating connection of a microphone apparatus according to an embodiment of the present invention;

FIG. 4 is a circuit diagram of a typical conventional microphone apparatus; and

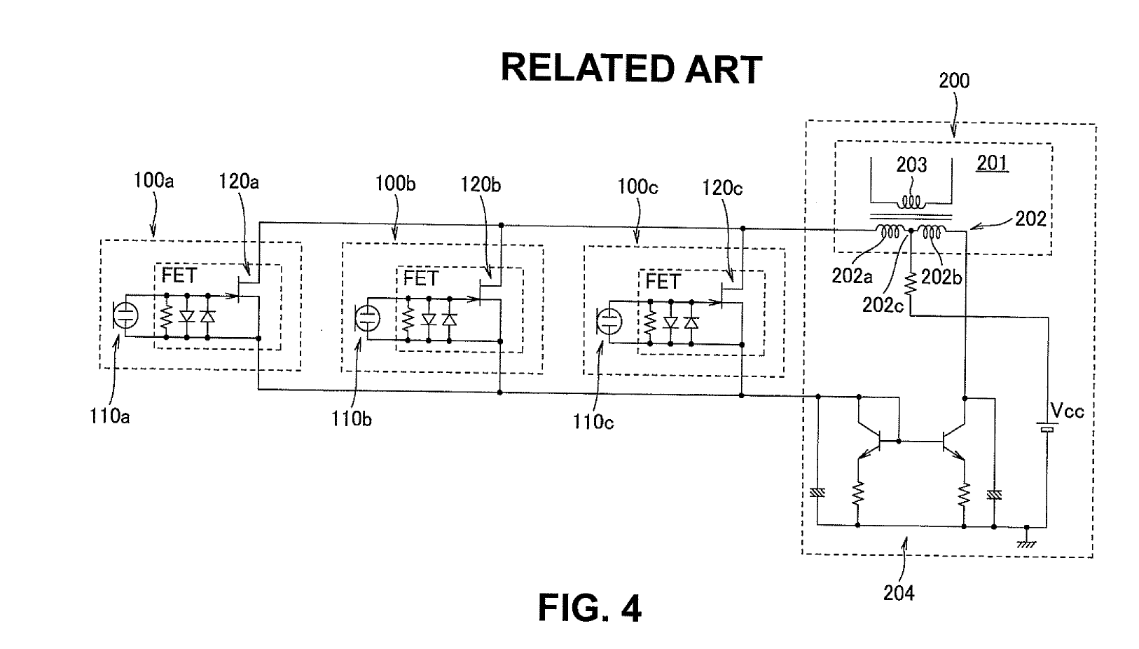

FIG. 5 is a schematic circuit diagram illustrating a configuration of a conventional microphone of a drain output type (two-wire system).

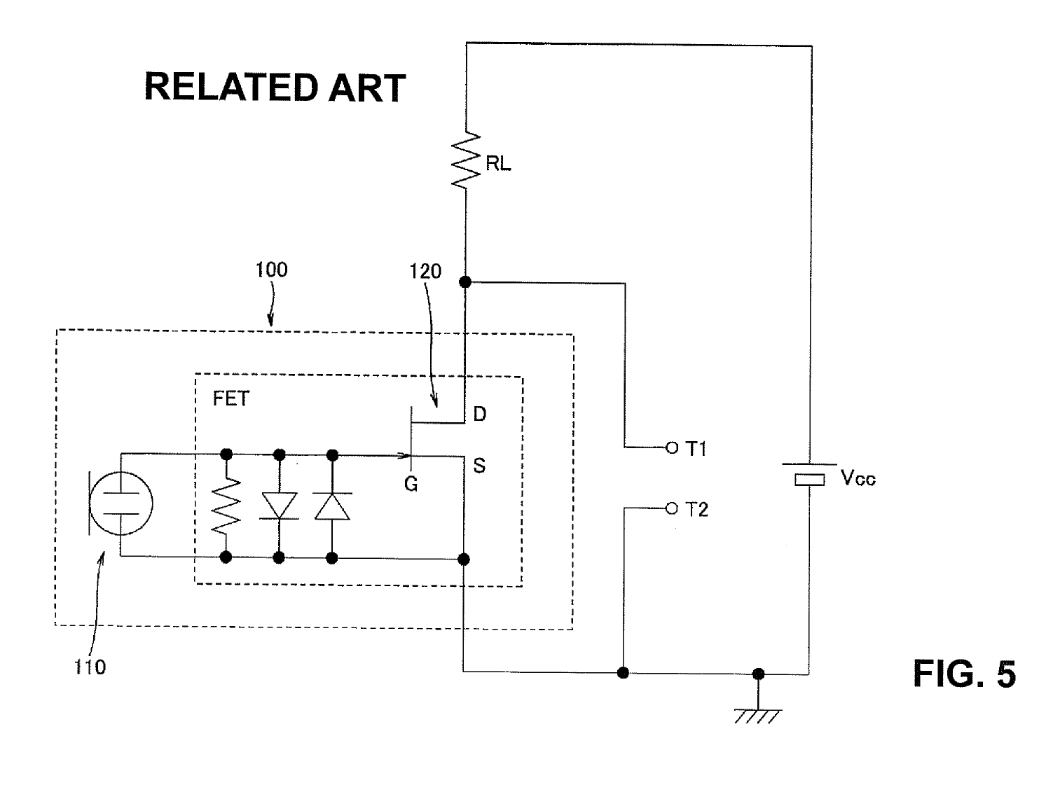

### DESCRIPTION OF THE PREFERRED EMBODIMENTS

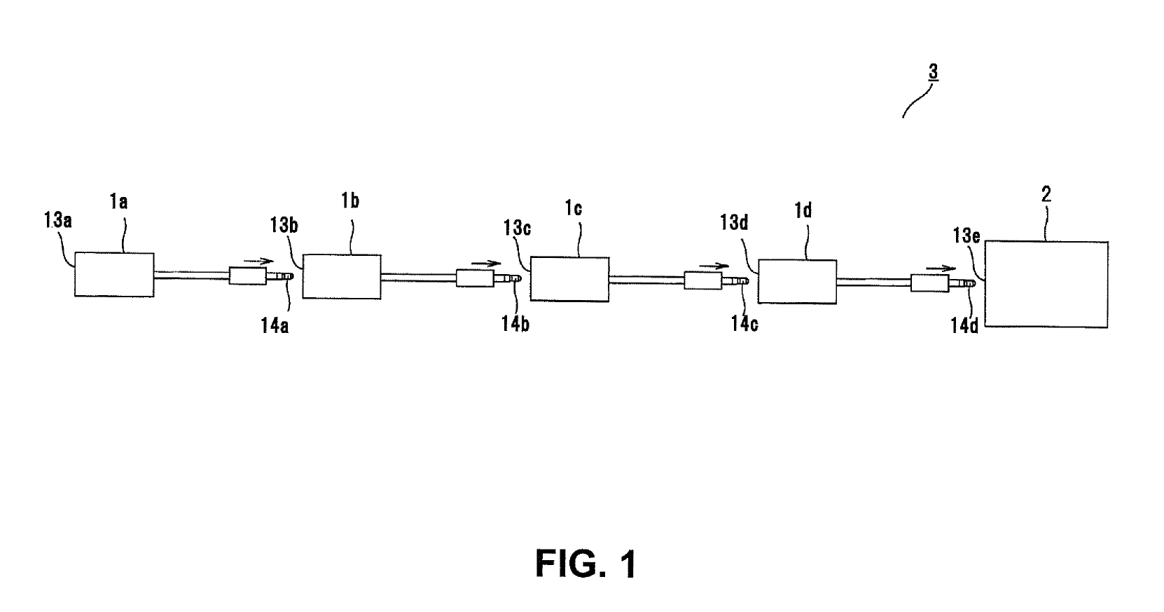

A microphone and a microphone apparatus according to an embodiment of the present invention are explained below with reference to the attached drawings. FIG. 1 is a schematic view of the microphone and the microphone apparatus according to the embodiment of the present invention. In a microphone apparatus 3 shown in FIG. 1, a plurality of microphones 1a to 1d are connected nose to tail in series and the last-stage microphone 1d is connected to a device 2 that includes a power source. Each of the microphones 1a to 1d has plugs 14a to 14d as output terminals and jacks 13a to 13d as input terminals (not shown in the drawing) provided on the left side in FIG. 1. The plug 14a of the first-stage microphone 1a is connected to the jack 13b of the second-stage microphone 1b, and the plug 14b of the second-stage microphone 1b is connected to the jack 13c of the third-stage microphone 1c. Continuously making such a connection provides nose-to-tail connection or daisy chain connection of the microphones 1a to 1d.

The plug 14d of the last-stage microphone 1d is connected to the device 2, from which an operating current is supplied from the power source included in the device 2 through a jack 13e thereof. The operating current is supplied from the last-stage microphone 1d toward the first-stage microphone 1a through the connection of the jacks 13a to 13d and the plugs 14a to 14d of the respective microphones 1a to 1d. Specifically, the microphones 1a to 1d are connected in parallel to the power source.

According to the microphones and the microphone apparatus of the present invention, the plurality of microphones are daisy-chain connected to the power source, thus reducing installation work, such as wiring for connection of a large number of microphones.

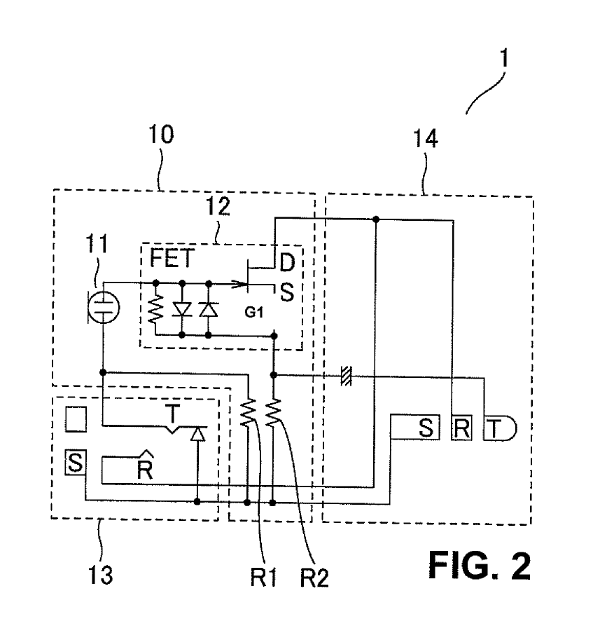

The microphone according to the present invention is described below in more detail. FIG. 2 is a circuit diagram illustrating the microphone according to an embodiment of the present invention. In FIG. 2, a microphone 1 has a microphone unit 10, which is an electret condenser microphone unit; a jack 13 as an input terminal; and a plug 14 as an output terminal. The microphone 1 in FIG. 2 indicates the microphones 1a to 1d in FIG. 1, and a configuration and a function thereof are similar to those of the microphones 1a to 1d. A configuration and a function of the jack 13 are similar to those of the jacks 13a to 13d. A configuration and a function of the plug 14 are similar to those of the plugs 14a to 14d.

The microphone unit 10 includes a microphone capsule 11 that has an electret member in either a diaphragm or a fixed electrode and a FET 12 as an impedance converter. The fixed electrode of the microphone capsule 11 is connected to a gate G of the FET 12. The diaphragm of the microphone capsule 11 is connected to a signal terminal T of the jack 13 and to the plug 14 and a ground terminal S of the jack 13 through a resistor R1. A drain D of the FET 12 is connected to a power source terminal R of the plug 14. A source S is connected to a signal terminal T of the plug 14 through a coupling capacitor and to the plug 14 and the ground terminal S of the jack 13 through a resistor R2.

The plug 14 has three terminals, i.e., the signal terminal T connected to the coupling capacitor, the power source terminal R, and a ground terminal S.

The jack 13 has also three terminals that correspond to those of the plug 14. In detail, the jack 13 includes the signal terminal T, a power source terminal R, and the ground terminal S, which correspond to the three respective terminals (i.e., the signal terminal T, the power source terminal R, and the ground terminal 5) of the plug 14. FIG. 2 illustrates a state where a plug 14 of another microphone 1 is not inserted into the jack 13. As shown in FIG. 2, the signal terminal T of the jack 13 is grounded in the state where the plug 14 is not inserted into the jack 13. Specifically, the diaphragm of the microphone capsule 11 is grounded, thus allowing the microphone 1 to operate as a stand-alone microphone as well.

When the plug 14 of another microphone (subsequent microphone) 1 (not shown in the drawing) is inserted into the jack 13, the signal terminal T of the jack 13 is disconnected from the ground and is connected to a signal terminal T of the plug 14 of the subsequent microphone 1. In other words, the signal terminal T of the plug 14 of the subsequent microphone 1 is connected to the diaphragm of the preceding microphone 1 and signals from the subsequent microphone 1 are ready to be added to audio signals. Added audio signals are output from the signal terminal T of the plug 14 of the preceding microphone 1. In the preceding microphone 1 into which the plug 14 of the subsequent microphone 1 is inserted, the diaphragm of the microphone capsule 11 is grounded through the resistor R1, thus ensuring audio signal output.

The operating current of the preceding microphone 1 is supplied through the power source terminal R of the plug 14 connected to the subsequent microphone 1. Since the power source terminal R is connected to the drain D of the FET, the operating current is supplied to the drain D of the FET 12 and is further supplied to the preceding microphone 1 through the power source terminal R of the jack 13 thereof. Thus, in daisy chain connection in which the plug 14 is inserted into the jack 13 of a subsequent microphone 1 to make a nose-to-tail connection, the operating current supplied from the power source (not shown in the drawing) is sequentially supplied through the plug 14 and the jack 13. Specifically, disconnecting the plug 14 from the jack 13 allows the microphones 1 according to the embodiment to each operate as a stand-alone microphone, while connecting the jack 13 to the plug 14 electrically connects the terminal of the diaphragm and the preceding output terminal, thus outputting added audio signals output from the microphones 1.

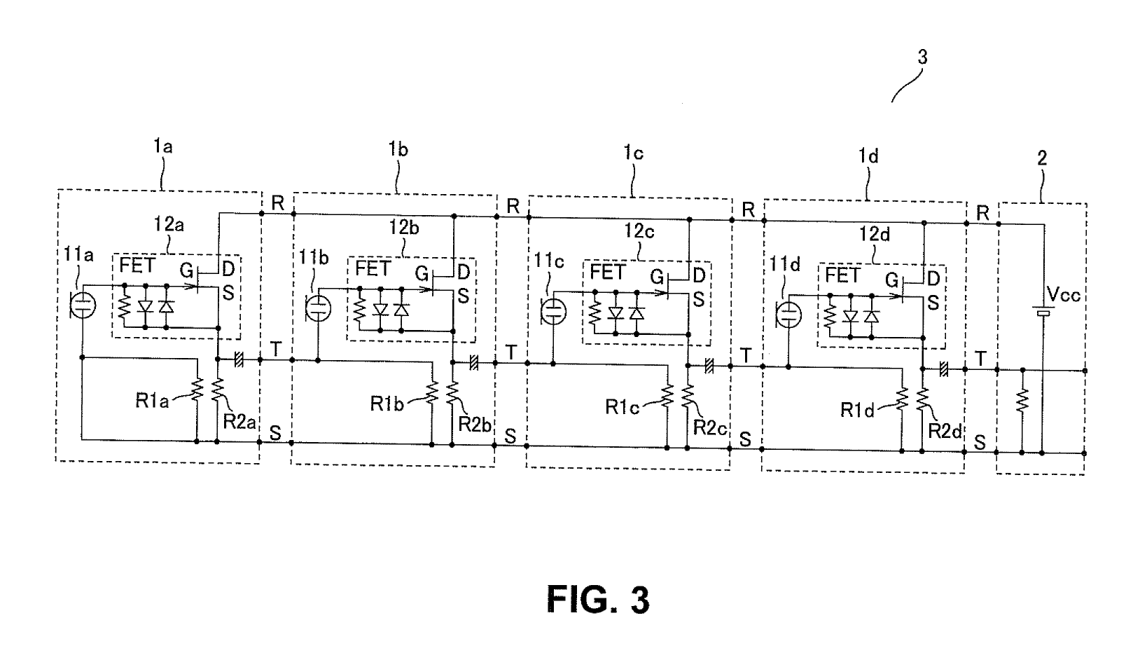

An embodiment is described below with reference to FIG. 3 in which microphones of the present embodiment are daisy-chain connected to operate as a microphone apparatus. With reference to FIG. 3, a microphone apparatus 3 has a plurality of microphones 1a to 1d and a device 2 that includes a power source Vcc. The four microphones (1a to 1d) are used in the embodiment for explanation purposes. The microphone apparatus of the present invention, however, is not limited to this number of microphones and may have a larger number of microphones to be connected within the permissible range of operating current supplied from the power source.

Plugs 14 and jacks 13 are omitted in FIG. 3. As shown in the drawing, power source terminals R of the respective microphones 1a to 1d are connected to drains D of FETs 12, each of which serves as an impedance converter, of the respective microphones 1a to 1d and then to the power source Vcc. Ground terminals S are connected to diaphragms of the respective microphones 1a to 1d through resistors R1a, R1b, R1c, and R1d, respectively. Signal terminals T, which are signal output terminals of the respective microphones 1a to 1d, are each connected to the diaphragm of the subsequent microphone 1. Thus, the respective microphones 1a to 1d are connected in parallel with respect to the power source and in series with respect to the audio signals. In FIG. 3, resistors R2a, R2b, R2c, and R2d are connected between sources of the FETs of the respective microphones 1a to 1d and the ground.

The FET 12, which is a drain-grounded circuit, has an amplification of substantially 1. Thus, even if audio signals output from the plurality of microphones 1 are connected in series, the signals are not amplified excessively and are output according to the input from the microphone units 11 of the respective microphones 1. The microphone apparatus according to the present invention can thus add signals input from the plurality of microphones into single signals for output without fluctuation in the level regardless of addition of the signals.

As described above, the microphone apparatus according to the present invention does not require a current mirror circuit or an output transformer in the output circuit. With the source follower configuration, the microphone apparatus has low AC impedance and audio signals are less susceptible to external noise.

The microphone apparatus having microphones connected in parallel according to the present invention is applicable, for example, to a microphone apparatus in a conference room and a security system used along with a security camera.

What is claimed is:

1. A microphone comprising:
a microphone unit comprising a diaphragm, a fixed electrode and a FET as an impedance converter;
a plug outputting audio signals output from the microphone unit; and
a jack into which audio signals inputted in the microphone unit are inputted, wherein
the microphone is connectable to an other microphone that is different from the microphone,
one of the diaphragm and the fixed electrode is comprised of an electret member,
the jack is connectable to a plug of the other microphone, and
while the plug of the other microphone is inserted in the jack the audio signals output from a microphone unit of the other microphone are added to the audio signals output from the microphone unit and are output.

2. The microphone according to claim 1, wherein
while the plug of the other microphone is not inserted in the jack of the microphone, the jack is grounded, and
while the plug of the other microphone is inserted in the jack of the microphone, the signal terminal of the jack and a signal terminal of the plug are connected.

3. The microphone according to claim 2, wherein the plug and the jack each include a signal terminal, a power source terminal, and a ground terminal.

4. A microphone apparatus comprising a plurality of nose-to-tail connected microphones according to claim 1.

5. A microphone apparatus comprising:
a microphone unit comprising a diaphragm, a fixed electrode and a FET as an impedance converter;
a plug outputting audio signals output from the microphone unit; and
a jack into which audio signals inputted in the microphone unit are inputted, wherein
while the plug of an other microphone is inserted in the jack of the microphone, a signal line of the diaphragm of the microphone unit and the plug of the other microphone are electrically connected and the audio signals output from the other microphone are added to the audio signals output from the microphone and are output.
